(19) United States
(12) Patent Application Publication
(10) Pub. No.: US 2025/0217913 A1
(43) Pub. Date: Jul. 3, 2025

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventor: Yoshimi KONDO, Nagoya-shi (JP)

(73) Assignee: TOYOTA JIDOSHA KABUSHIKI KAISHA, Toyota-shi (JP)

(21) Appl. No.: 18/999,110

(22) Filed: Dec. 23, 2024

(30) Foreign Application Priority Data
Dec. 28, 2023 (JP) 2023-223184

(51) Int. Cl. G06Q 50/20; G06Q 10/0631

(52) U.S. Cl. CPC G06Q 50/2057; G06Q 10/063118

(57) ABSTRACT

An information processing apparatus acquires information on an operation route to operate an vehicle, extracts an operational caution from the acquired information on the operation route, acquires, from the vehicle during traveling on the operation route, measurement data measured by the vehicle and information on a near miss experienced by a crew member of the vehicle, and formulates a training plan that combines the information on the operation route, the operational caution, the measurement data, and the information on the near miss.

### CROSS-REFERENCE TO RELATED APPLICATION

This application claims priority to Japanese Patent Application No. 2023-223184 filed on Dec. 28, 2023, the entire contents of which are incorporated herein by reference.

### TECHNICAL FIELD

The present disclosure relates to an information processing apparatus and an information processing method.

### BACKGROUND

Technology related to training employees involved in the vehicle operation business is known. For example, Patent Literature (PTL) 1 discloses a training system that provides training to such employees in the form of answering questions.

### CITATION LIST

### Patent Literature

PTL 1: JP 2019-219474 A

### SUMMARY

Operators (municipalities or the like) that operate automated driving vehicles do not have operational know-how for employee training. Additionally, such operators are required to formulate training plans that respond to operation routes and operating conditions that change daily, which increases the economic burden. Therefore, there is room for improvement with respect to technology related to training employees involved in the vehicle operation business.

It would be helpful to improve technology related to training employees involved in the vehicle operation business.

An information processing apparatus according to an embodiment of the present disclosure is an information processing apparatus for formulating a training plan for an employee, the information processing apparatus including a controller configured to:
acquire information on an operation route to operate an vehicle;
extract an operational caution from the acquired information on the operation route;
acquire, from the vehicle during traveling on the operation route, measurement data measured by the vehicle and information on a near miss experienced by a crew member of the vehicle; and
formulate a training plan that combines the information on the operation route, the operational caution, the measurement data, and the information on the near miss.

An information processing method according to an embodiment of the present disclosure is an information processing method performed by an information processing apparatus for formulating a training plan for an employee, the information processing method including:
acquiring information on an operation route to operate an vehicle;
extracting an operational caution from the acquired information on the operation route;
acquiring, from the vehicle during traveling on the operation route, measurement data measured by the vehicle and information on a near miss experienced by a crew member of the vehicle; and
formulating a training plan that combines the information on the operation route, the operational caution, the measurement data, and the information on the near miss.

According to an embodiment of the present disclosure, technology related to training employees involved in the vehicle operation business is improved.

### BRIEF DESCRIPTION OF THE DRAWINGS

In the accompanying drawings:

FIG. 1 is a block diagram illustrating a schematic configuration example of a system according to an embodiment of the present disclosure;

FIG. 2 is a flowchart illustrating an operation example of an information processing apparatus;

FIG. 3 is a schematic diagram illustrating an example of information on an operation route; and

FIG. 4 is a schematic diagram illustrating an example of a training plan.

### DETAILED DESCRIPTION

Hereinafter, an embodiment of the present disclosure will be described.

### Outline of Embodiment

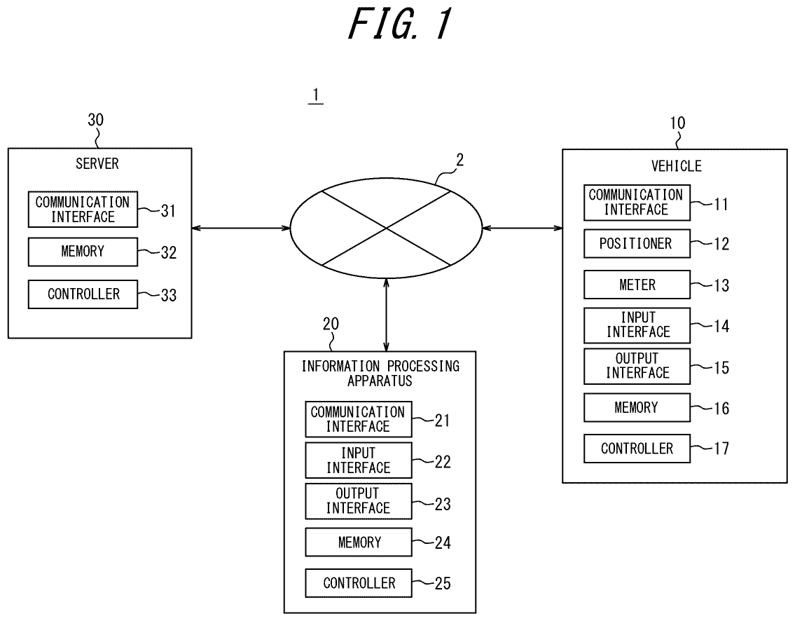

An outline of a system 1 according to an embodiment of the present disclosure will be described with reference to FIG. 1. The system 1 includes a vehicle 10, an information processing apparatus 20, and a server 30. The vehicle 10, the information processing apparatus 20, and the server 30 are communicably connected to a network 2 including, for example, the Internet, a mobile communication network, and the like.

The vehicle 10 is an automobile, for example, but is not limited to this and may be any appropriate vehicle. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The vehicle 10 may be an automated driving vehicle. The number of vehicles 10 provided in the system 1 may be freely determined. The vehicle 10 is communicably connected to the information processing apparatus 20 via the network 2.

The information processing apparatus 20 is, for example, a computer such as a server apparatus. The information processing apparatus 20 is communicably connected to the vehicle 10 and the server 30 via the network 2.

The server 30 is, for example, a computer of an operator that provides a distribution service for information on operation routes. The server 30 is communicably connected to the information processing apparatus 20 via the network 2.

First, an outline of the present embodiment will be described, and details thereof will be described later. The information processing apparatus 20 acquires information on an operation route to operate the vehicle 10, extracts an operational caution from the acquired information on the operation route, acquires, from the vehicle 10 during traveling on the operation route, measurement data measured by the vehicle 10 and information on a near miss experienced by a crew member of the vehicle 10, and formulates a training plan that combines the information on the operation route, the operational caution, the measurement data, and the information on the near miss.

Thus, according to the present embodiment, even if the vehicle operator does not have the operational know-how for employee training, it is possible to formulate a training plan by the use of the information processing apparatus 20. Thus, the technology related to training employees involved in the vehicle operation business is improved in that the economic burden on vehicle operators to formulate training plans that respond to changes in operation routes and operating conditions is reduced.

Next, configurations of the system 1 will be described in detail.

### Configuration of Vehicle

As illustrated in FIG. 1, the vehicle 10 includes a communication interface 11, a positioner 12, a meter 13, an input interface 14, an output interface 15, a memory 16, and a controller 17.

The communication interface 11 includes at least one interface for communication for connecting to the network 2. The communication interface is compliant with a mobile communication standard such as the 4th generation (4G) standard or the 5th generation (5G) standard, an in-vehicle network (e.g., a Controller Area Network (CAN), or the like, for example, but is not limited to these. In the present embodiment, the vehicle 10 communicates with the information processing apparatus 20 via the communication interface 11 and the network 2.

The positioner 12 includes one or more apparatuses that acquire information on a position of the vehicle 10. Specifically, the positioner 12 includes, for example, a receiver compliant with GPS, but is not limited to this example and may include a receiver compliant with any appropriate satellite positioning system. Information on a position is information on the latitude and longitude of the target point.

The meter 13 includes one or more apparatuses that collect data inside and outside the vehicle 10. Specifically, one or more apparatuses, such as pressure sensors, exhaust gas sensors, accelerometers, gyro sensors, ultrasonic sensors, millimeter wave radar, infrared radar, or cameras (hereinafter also referred to as in-vehicle cameras), measure and collect data inside and outside the vehicle 10. However, the one or more apparatuses are not limited to these. Ultrasonic sensors, millimeter wave radar, infrared radar, or cameras may be used as anti-collision sensors or obstacle detection sensors.

The input interface 14 is configured to include at least one interface for input that is capable of accepting input by the crew member of the vehicle 10. The interface for input is, for example, a physical key, a capacitive key, a pointing device, a camera, a touch screen integrally provided with a display of the output interface 15 described below, a microphone that inputs voice of the driver, or the like. However, the interface for input is not limited to these.

The output interface 15 is configured with at least one audio output interface that can output audio, and at least one display interface that can display text or video. The audio output interface is, for example, a speaker. The display interface is, for example, a display such as an LCD or an organic EL display. However, the audio output interface and the display interface are not limited to these.

The memory 16 includes one or more memories. The memories are, for example, semiconductor memories, magnetic memories, optical memories, or the like, but are not limited to these. The memories included in the memory 16 may each function as, for example, a main memory, an auxiliary memory, or a cache memory. The memory 16 stores any information to be used for operations of the vehicle 10. For example, the memory 16 may store a system program, an application program, embedded software, map information, and the like. The information stored in the memory 16 may be updated with, for example, information acquired from the network 2 via the communication interface 11.

The controller 17 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 17 controls operations of the entire vehicle 10.

### Configuration of Information Processing Apparatus

As illustrated in FIG. 1, the information processing apparatus 20 includes a communication interface 21, an input interface 22, an output interface 23, a memory 24, and a controller 25.

The communication interface 21 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the vehicle 10 and the server 30 via the communication interface 21 and the network 2.

The input interface 22 is configured with at least one interface for input that can accept input from the employees of the vehicle operation business. The interface for input is, for example, a physical key, a capacitive key, a pointing device, a camera, a touch screen integrally provided with a display of the output interface 23 described below, a microphone that inputs voice of the employees, or the like. However, the interface for input is not limited to these.

The output interface 23 is configured with at least one audio output interface that can output audio, and at least one display interface that can display text or video. The audio output interface is, for example, a speaker for voice response to questions from employees. The display interface is, for example, a display such as an LCD or an organic EL display. However, the audio output interface and the display interface are not limited to these.

The memory 24 includes one or more memories. The memories included in the memory 24 may each function as, for example, a main memory, an auxiliary memory, or a cache memory. The memory 24 stores any information to be used for operations of the information processing apparatus 20. For example, the memory 24 may store system programs, application programs, databases, information on operation routes acquired from the server 30, operational cautions extracted from information on operation routes, measurement data and information on a near miss acquired from the vehicle 10. The information stored in the memory 24 may be updated with, for example, information acquired from the network 2 via the communication interface 21.

The controller 25 includes at least one processor, at least one programmable circuit, at least one dedicated circuit, or a combination of these. The controller 25 controls the operations of the entire information processing apparatus 20.

### Configuration of Server

As illustrated in FIG. 1, the server 30 includes a communication interface 31, a memory 32, and a controller 33.

The communication interface 31 includes at least one interface for communication for connecting to the network 2. The communication interface is compliant with a wired LAN standard or a wireless LAN standard, for example, but is not limited to these, and may be compliant with any communication standard. In the present embodiment, the server 30 communicates with the information processing apparatus 20 via the communication interface 31 and the network 2.

The memory 32 includes one or more memories. The memories included in the memory 32 may each function as, for example, a main memory, an auxiliary memory, or a cache memory. The memory 32 stores any information used for operations of the server 30. For example, the memory 32 may store a system program, an application program, a database, information on operation routes throughout the country or in some regions, and the like. The information stored in the memory 32 may be updated with, for example, information acquired from the network 2 via the communication interface 31.

The controller 33 includes at least one processor, at least one programmable circuit, at least one dedicated circuit, or a combination of these. The controller 33 controls the operations of the entire server 30.

### Flow of Operations of Information Processing Apparatus

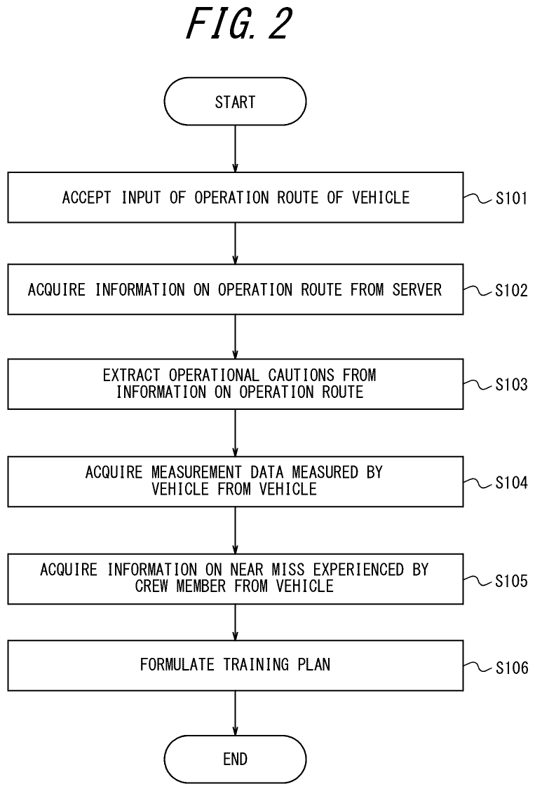

Operations of the information processing apparatus 20 according to the present embodiment will be described with reference to FIG. 2. These operations relate to formulation of a training plan.

S101: The controller 25 accepts an operation route r of the vehicle 10.

The operation route r is the route along which the vehicle 10 is operated by the vehicle operator. The controller 25 accepts the operation route r inputted to the input interface 22 by the vehicle operator.

S102: The controller 25 acquires information on the operation route r to operate the vehicle 10 from the server 30.

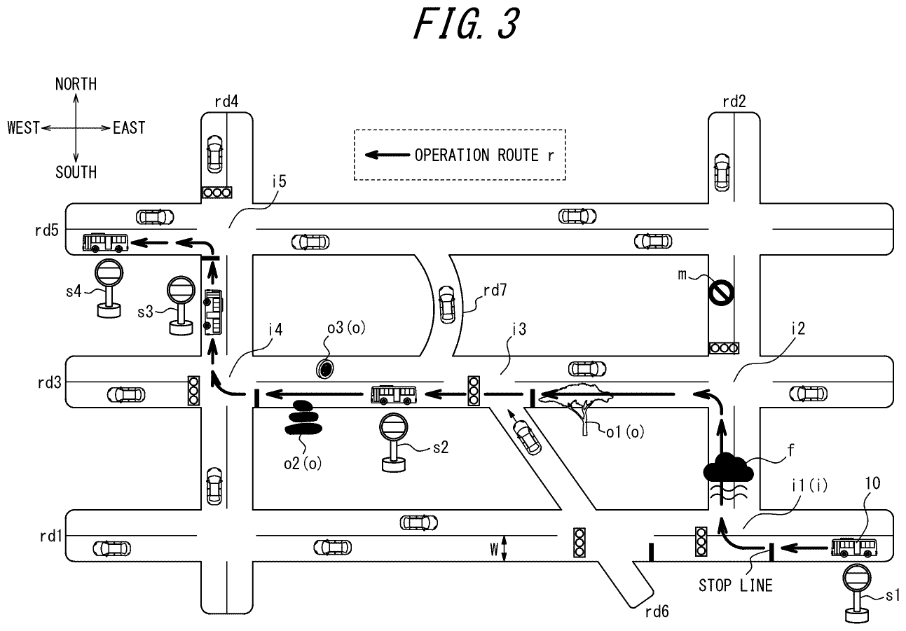

FIG. 3 is a schematic diagram illustrating an example of information on an operation route. As illustrated in FIG. 3, the operation route r is the route from stop s1 to stop s4 via stops s2 and s3. To describe the operation route r in more detail, the vehicle 10 (i) departs a stop s1 and proceeds west on a road rd1, (ii) turns right at an intersection i2 and proceeds north on a road rd2, (iii) turns left at an intersection i2 and proceeds west on a road rd3, passes straight through an intersection i3 and stops at a stop s2, (iv) departs the stop s2 then turns right at an intersection i4 and proceeds north on a road rd4 to stop at a stop s3, and (v) after departing the stop s3, turns left at an intersection i5 and proceeds west on a road rd5 to a stop s4. In addition to the map information displaying the operation route r, the information on the operation route includes the roads rd (rd1 to rd7) that make up the operation route r and the intersections i (i1 to i5) where at least two of roads rd1 to rd7 intersect, the lane information for each road rd (in the example in FIG. 3, rd1 to rd5 are one-lane roads, rd6 and rd7 are one-way roads) and lane widths w, the stops s (s1 to s4) located along the operation route r, and information on traffic rules such as traffic lights, stop lines and road signs m. The information on the operation route may further include an image of the operation route r. The image can be a still or moving image. The still image is an image of, for example, a lane, a stop s, a traffic light, or various road signs m. The moving image is, for example, a continuous image of all or part of the operation route r from the stop s1 to the stop s4 via the stops s2 and s3. The controller 25 stores the acquired information on the operation route in the memory 24.

S103: The controller 25 extracts operational cautions from the acquired information on the operation route r.

The controller 25 extracts the following (i)-(iii) as operational cautions, for example. (i) Just before the intersection i3 with poor visibility, a tree o1(o) is overhanging the road rd3 and the tree o1(o) is a blind spot, so the vehicle 10 traveling on the road rd3 must be careful of vehicles entering the intersection i3 from the left ahead on the road rd6. In addition, (ii) there are rocks o2(o) on the roadside on the road rd3 between the stop s3 and the intersection i4, so the vehicle 10 needs to avoid the rocks o2. In addition, (iii) if any of the roads rd (rd1 to rd7) that make up the operation route r is closed (the lane indicated by the road sign m in FIG. 3), a detour route will be presented, which requires attention. In addition, the operational cautions may be added, such as a case of an emergency stop due to misidentification by the vehicle 10, which will be described later. The operational cautions include, but are not limited to these.

S104-S105: The controller 25 acquires, from the vehicle 10 during traveling on the operation route r, the measurement data measured by the vehicle 10 and information on the near miss experienced by the crew member of the vehicle 10.

The measurement data measured by the vehicle 10 includes information on the position of the vehicle 10 measured by the receiver corresponding to the satellite positioning system. The measurement data also includes an image of the operation route r captured by the in-vehicle camera. The image can be a still or moving image. The still image is an image of, for example, a lane, a stop s, a traffic light, or various road signs m. The moving image is, for example, a continuous image of all or part of the section from stop s1 to stop s4 on the operation route r. In addition, the measurement data includes information (information on a position and shape or image information) on the obstacle (o) detected by sensors (using ultrasonic sensors, millimeter wave radar, infrared radar, or in-vehicle cameras) that detect obstacles. The detected obstacle (o) includes, for example, trees o1(o) growing on the side of the road, rocks o2(o) protruding from the side of the road, or objects or body parts (in the example in FIG. 3, tires o3(o)) falling from a vehicle traveling ahead, but is not limited to these. The controller 25 acquires the measurement data transmitted from the vehicle 10 via the network 2 and the communication interface 21. The controller 25 stores the acquired measurement data in the memory 24. The memory 24 may accumulate and store measurement data transmitted from the vehicle 10 that has operated on the operation route r within a predetermined time period in the past.

The controller 25 may add cases of emergency stops due to misidentification of the vehicle 10 identified from the measurement data to the operational cautions. For example, the controller 25 may add a case in which the vehicle 10 with an automated driving function misidentifies the fog f generated during operation as an obstacle o and made an emergency stop, as measured by an anti-collision sensor or a sensor that detects obstacles to the operational caution together with the information on the position of the point where the misidentification occurred and the weather conditions at the time the misidentification occurred. For example, the controller 25 may add a case in which the vehicle 10 with an automated driving function during traveling in one lane misidentifies another vehicle in front of it after a forced overtaking as an obstacle o and made an emergency stop to the operational caution along with a moving image captured at the point of occurrence at the time the misidentification occurred. The controller 25 may store cases of emergency stops due to misidentification of the vehicle 10 in the memory 24.

A near miss refers to the recognition of a case that does not lead to a serious accident or disaster, but is one step short of a direct cause. The information on the near miss may include information on the position of the point where the near miss occurred and images captured at the point. The controller 25 acquires the information on the near miss transmitted from the vehicle 10 via the network 2 and the communication interface 21. The controller 25 stores the acquired information on the near miss in the memory 24. The memory 24 may accumulate and store information on near misses transmitted by the vehicle 10 that operated on the operation route r during a predetermined time period in the past.

The controller 25 may certify the occurrence of a near miss when it acquires information on a near miss with the same or similar content from a point included in a predetermined area within the operation route r more than a predetermined number of times. This is to eliminate the chance of near misses occurring. If the information on the position of the point where the near miss occurred, which is included in the information on the near miss and the information on the position of the point where the obstacle o was detected, which is included in the measurement data, are within a predetermined area, the controller 25 may store in the memory 24 the obstacle o in association with the occurrence of the near miss. This is because a causal relationship between the obstacle o (cause) and the experience of a near miss (result) is presumed.

S106: The controller 25 formulates a training plan that combines information on the operation route, operational cautions, measurement data, and information on near misses.

The controller 25 formulates a training plan for each operation route. The controller 25 may generate training materials (moving images) for traveling simulation based on moving images of all or some of the sections of the operation route r from stop s1 to stop s4 continuously captured, which are included in the information on the operation route or the measurement data.

The controller 25 may formulate a training plan based on the attribute of the employee. The attribute of the employee is, for example, the operation manager who manages the operation of the vehicle 10 in the office, the crew members who are on board the vehicle 10, and so on, within the vehicle operators.

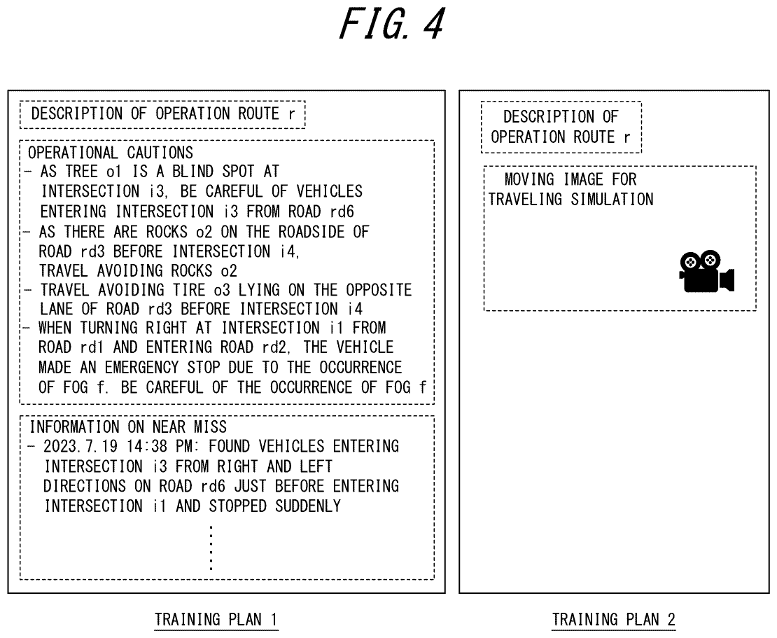

FIG. 4 is a schematic diagram illustrating an example of a training plan. The controller 25, for example, makes the description of the operation route a common training matter for all employees. Additionally, the controller 25 may present a training plan 1, which uses operational cautions and the position and images where the near miss occurred, to the operation manager, and a training plan 2, which uses training materials (moving images) for traveling simulation, to the crew members. However, the training plan is not limited to these items.

As described above, the information processing apparatus 20 according to the present embodiment acquires information on the operation route to operate the vehicle 10, extracts an operational caution from the acquired information on the operation route, acquires measurement data measured by the vehicle 10 during traveling on the operation route and information on a near miss experienced by the crew member of the vehicle 10, and formulates a training plan that combines the information on the operation route, the operational caution, the measurement data, and the information on the near miss.

According to this configuration, even if the vehicle operator does not have the operational know-how for employee training, it is possible to formulate a training plan by the use of the information processing apparatus 20. Thus, the technology related to training employees involved in the vehicle operation business is improved in that the economic burden on vehicle operators to formulate training plans that respond to changes in operation routes and operating conditions is reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, the functions and the like included in each component, step, or the like can be rearranged in a logically consistent manner. Components, steps, or the like may also be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, the controller in the vehicle 10 may perform some or all of the functions of the information processing apparatus 20.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus for formulating a training plan for an employee, the information processing apparatus comprising a controller configured to:
acquire information on an operation route to operate an vehicle;
extract an operational caution from the acquired information on the operation route;
acquire, from the vehicle during traveling on the operation route, measurement data measured by the vehicle and information on a near miss experienced by a crew member of the vehicle; and
formulate a training plan that combines the information on the operation route, the operational caution, the measurement data, and the information on the near miss.

2. The information processing apparatus according to claim 1, wherein the measurement data includes information on a position of the vehicle measured by a receiver, information on an obstacle detected by a sensor, and information of an image captured by an in-vehicle camera.

3. The information processing apparatus according to claim 1, wherein the controller is configured to add a case of an emergency stop due to misidentification by the vehicle identified from the measurement data to the operational caution.

4. The information processing apparatus according to claim 1, wherein the controller is configured to formulate the training plan according to an attribute of the employee.

5. An information processing method performed by an information processing apparatus for formulating a training plan for an employee, the information processing method comprising:
acquiring information on an operation route to operate an vehicle;
extracting an operational caution from the acquired information on the operation route;
acquiring, from the vehicle during traveling on the operation route, measurement data measured by the vehicle and information on a near miss experienced by a crew member of the vehicle; and
formulating a training plan that combines the information on the operation route, the operational caution, the measurement data, and the information on the near miss.
